(19) United States
(12) Patent Application Publication
(10) Pub. No.: US 2009/0167563 A1
(43) Pub. Date: Jul. 2, 2009

(54) INTEGRATED INTERSECTION TRAFFIC CONTROL SYSTEM

(75) Inventor: Zhilong LIANG, Beijing (CN)

Correspondence Address: YING CHEN;Chen Yoshimura LLP, 255 S. GRAND AVE., # 215, LOS ANGELES, CA, 90012, US

(73) Assignee: AOCHENGTONGLI S&T DEVELOPMENT ( BEIJING ) CO., LTD, Beijing (CN)

(21) Appl. No.: 12/110,462

(22) Filed: Apr. 28, 2008

(30) Foreign Application Priority Data
Dec. 26, 2007 (CN) 200710303840.5

(51) Int. Cl. G08G 1/00

(52) U.S. Cl. 340/928

(57) ABSTRACT

This invention relates to an integrated intersection traffic control system. The system comprises a statistic module for creating traffic data of each lane and each direction, an intelligent light control module for creating queuing data of the corresponding lane and direction, a vehicle speed detection module for creating speed data, a snapshot control module for crating snapshot control signals, a light control module for receiving lighting mode control commands from a CPU and switching on/off corresponding light power supply circuits, and a CPU for receiving data from other modules and devices and controlling them. The present invention integrates functions including traffic condition monitoring, traffic light control and punishable vehicle snapshoot. Such an integrated system is more economical and easier to construct and operate.

### BACKGROUND OF THE INVENTION

1. Field of the Invention

This invention relates to information technology, and more particularly, to an integrated intersection traffic control system.

2. Description of the Related Art

In the existing intersection traffic management, different electronic control systems of separate functions including traffic light control, traffic condition monitoring and punishable vehicle snapshoot are used. Such a system is applicable while its functions and structure are simple. As more sophisticated and interdependent functions are needed in traffic management, the using of simple systems would waste hardware resource and need a more complicate communication. For example, continuous pictures need to be taken both for the adjusting of lighting mode in response to current traffic condition and the detecting of speeding vehicles. In the other hand, new information technology has enabled a single microprocessor to handle huge data. So, an integrated intersection traffic control system is expected.

### SUMMARY OF THE INVENTION

To overcome the above disadvantages of the existing technology, the present invention provides an integrated intersection traffic control system, which has integrated functions including traffic condition monitoring, traffic light control and snapshoot of punishable vehicle.

The solution of the invention is as follows: an integrated intersection traffic control system, comprising:

a flow statistic module, for receiving information regarding vehicles passing through the underground inductance coil of each lane, processing the information into traffic data of each lane and each direction, and sending the traffic data to a CPU;

an intelligent light control module, for receiving from a panoramic camera pictures of vehicles on each lane and on each direction, processing the pictures into queuing data of the corresponding lane and direction, and sending the queuing data to the CPU;

a vehicle speed detection module, for receiving information regarding vehicles passing through the underground inductance coil of each lane, processing the information into speed data, and sending the speed data to the CPU;

a snapshot control module, for receiving snapshot commands from the CPU, creating snapshot control signals, and sending the snapshot control signals to snapshot cameras;

a light control module, for receiving lighting mode control commands from the CPU, creating light control signals in accordance with pre-stored lighting modes, and sending the light control signals to a light control circuit to switch on/off the corresponding power supply circuits, wherein the light control module receives light switching commands from the CPU whose execution will be given priority, creates and sends light control signals to the light control circuit to switch on/off the corresponding power supply circuits, and finally resumes the lighting mode after the light switching commands are executed; and

a CPU, for receiving and storing the traffic data of each lane and each direction, creating and storing analytic traffic data, and outputting the analytic traffic data in accordance with external commands; for receiving the queuing data of each lane and each direction as well as mode parameters input by a lighting mode selector, creating lighting mode control commands according to the mode parameters, and sending the lighting mode control commands to the light control module; for receiving light switching information input by a manual light switching device, creating light switching commands, and sending the light switching commands to the light control module; for receiving visibility data from a visibility sensor, retrieving a speed limit corresponding to the visibility data in a database, and storing the speed limit in a speed limit storage; for receiving the speed data from the vehicle speed detection module, comparing the speed data with the speed limit in the speed limit storage, and sending a snapshot command, if the speed data is greater than the speed limit, to the snapshot control module; and for receiving snapshot images from the snapshot cameras through a video capture card, recognizing the vehicle identification number, and storing the images and corresponding number in a blacklist database.

The advantages of this invention are: the various systems of prior art are integrated into one while each function is maintained, thereby simplifying the system structure as well as improving the functioning of the system and related devices. Such an integrated system is more economical and easier to construct and operate. In addition, this invention may take both longitudinal and lateral snapshots of vehicles, thus preventing indistinctness when only longitudinal snapshots are taken, and especially when red light glares on the vehicle identification plate at night. The invention may also monitor unusual speeding in a smoggy day by setting an unusual speed limit according to the visibility data obtained in real time by the visibility sensor. Compared with prior art snapshot system, for an intelligent light control module and a correlated panoramic camera are provided, this invention may adjust the traffic lights to an optimum lighting mode, i.e., switching sequence and timing, according to the queuing data of each lane, thereby preventing overcrowding on a particular lane due to bad traffic control.

### BRIEF DESCRIPTION OF THE DRAWINGS

FIG. 1 is a block diagram of the present invention.

### DESCRIPTION OF THE EMBODIMENTS

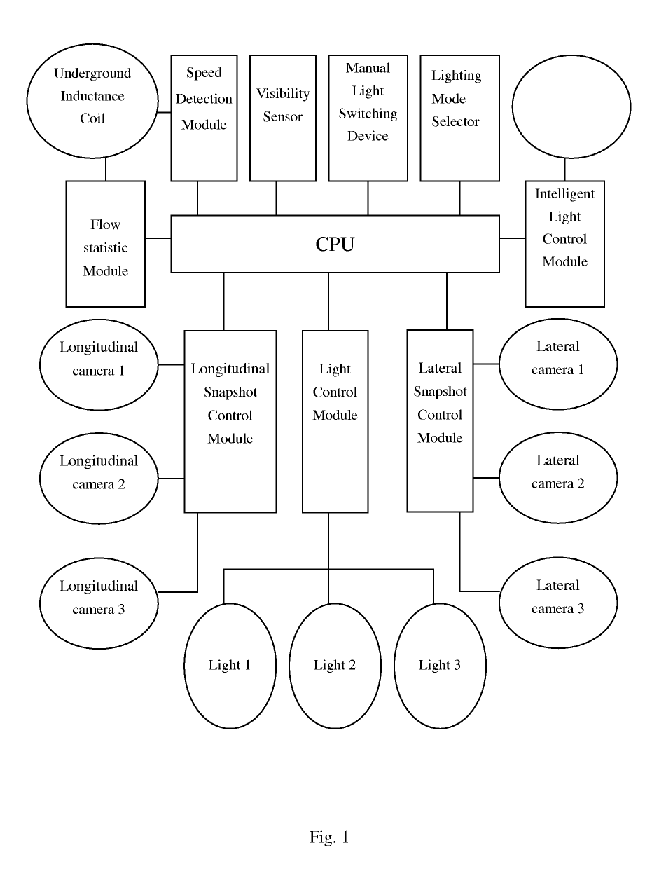

With reference to FIG. 1, this invention provides an integrated intersection traffic control system, comprising:

a flow statistic module, for receiving information regarding vehicles passing through the underground inductance coil of each lane, processing the information into traffic data of each lane and each direction, and sending the traffic data to a CPU;

an intelligent light control module, for receiving from a panoramic camera pictures of vehicles on each lane and on each direction, processing the pictures into queuing data of the corresponding lane and direction, and sending the queuing data to the CPU;

a vehicle speed detection module, for receiving information regarding vehicles passing through the underground inductance coil of each lane, processing the information into speed data, and sending the speed data to the CPU;

a snapshot control module, for receiving snapshot commands from the CPU, creating snapshot control signals, and sending the snapshot control signals to snapshot cameras;

a light control module, for receiving lighting mode control commands from the CPU, creating light control signals in accordance with pre-stored lighting modes, and sending the light control signals to a light control circuit to switch on/off the corresponding power supply circuits, wherein the light control module receives light switching commands from the CPU whose execution will be given priority, creates and sends light control signals to the light control circuit to switch on/off the corresponding power supply circuits, and finally resumes the lighting mode after the light switching commands are executed; and

a CPU, for receiving and storing the traffic data of each lane and each direction, creating and storing analytic traffic data, and outputting the analytic traffic data in accordance with external commands; for receiving the queuing data of each lane and each direction as well as mode parameters input by a lighting mode selector, creating lighting mode control commands according to the mode parameters, and sending the lighting mode control commands to the light control module; for receiving light switching information input by a manual light switching device, creating light switching commands, and sending the light switching commands to the light control module; for receiving visibility data from a visibility sensor, retrieving a speed limit corresponding to the visibility data in a database, and storing the speed limit in a speed limit storage; for receiving the speed data from the vehicle speed detection module, comparing the speed data with the speed limit in the speed limit storage, and sending a snapshot command, if the speed data is greater than the speed limit, to the snapshot control module; and for receiving snapshot images from the snapshot cameras through a video capture card, recognizing the vehicle identification number, and storing the images and corresponding number in a blacklist database.

The said snapshot cameras include longitudinal and lateral cameras respectively for taking longitudinal and lateral snapshots. The operation of the cameras is dependent on the vehicle speed detection module, the visibility sensor and the CPU. The longitudinal and lateral cameras take snapshots in response to the commands from the CPU and send the punishable vehicle images to the CPU. The vehicle speed detection module obtains the speed information. The CPU receives and processes the speed information into speed data, compares the speed data with the speed limit, makes a decision, if the actual speed is greater than the speed limit, that there is a speeding, and instantly commands the snapshot camera to take snapshots as well as recognizes the vehicle identification number by analyzing the picture. The visibility sensor captures and sends visibility data to the CPU to retrieve a pre-stored speed limit corresponding to the visibility level for comparison with the actual speed.

The CPU controls longitudinal and lateral snapshoot through corresponding longitudinal and lateral cameras. The CPU is provided with a master communication interface and connected with a red light detector for detecting the red light condition in real-time and sending the condition data to the CPU. The longitudinal and lateral cameras consist essentially of the master communication interface, a video controller and a camera communication interface. The vehicle speed detection module calculates the speed data according to the output of the underground inductance coil. The CPU creates speed limit data corresponding to the visibility data sent by the visibility sensor module and stores the speed limit data in the speed limit storage for future decision of whether there is a speeding.

The CPU has an embedded ARM4 processor and corresponding analysis and control programs that conduct prior art data gathering, error handling and logic operation to the input information regarding red light condition, traffic condition and vehicle's speed. Immediately after a red light violation or speeding is confirmed, the CPU sends related information through the master communication interface to the longitudinal and lateral snapshot control modules, the longitudinal and lateral snapshot control modules calculates the pair of best moment and position of the corresponding cameras and send to the cameras through the camera communication interface, and the cameras may correspondingly take a picture or video of what is happening right now.

The visibility sensor comprises a laser transmitter having a transmitting direction and a laser receiver having a receiving direction corresponding to the transmitting direction, wherein the visibility data is obtainable by calculating the ratio of the received light intensity to the transmitted light intensity, that is, the attenuation rate. The laser receiver has a photosensitive element for receiving laser, the photosensitive element being sensitive only to laser of one frequency, or a mask being disposed in front of the photosensitive element that allows only laser of one frequency passing. The laser receiver is equipped with a tubular shade for prevention of the background light.

Furthermore, a real-time speed limit display is disposed in front of the speed detection module, to inform drivers of the current speed limit.

The speed limit display is connected to the CPU so that the CPU may send, speed limit data stored in the speed limit storage to the speed limit display for display in real time.

The control on traffic lights eventually depends on the CPU while the lighting mode selector, the manual light switching device and the intelligent light control module control the lights by sending information to the CPU. The lighting mode selector sends light control parameters to the CPU, the manual light switching device assigns priority to some manual operation, and the intelligent light control module receives real-time videos of traffic condition on each direction from the panoramic cameras through the video capture card, analyzes the videos for queuing data of the vehicles, chooses an optimum lighting mode according to the queuing data, and sends commands to the light control module to change the light control parameters stored in the light control module.

The traffic light referenced in this context refers to a traffic signal of any type, whose color may be red, green or yellow, and whose direction indication may be forwards, left, right, backwards and none directional.

It will be apparent to those skilled in the art that various modification and variations can be made in the device of the present invention without departing from the spirit or scope of the invention. Thus, it is intended that the present invention cover modifications and variations that come within the scope of the appended claims and their equivalents.

What is claimed is:

1. An integrated intersection traffic control system, comprising:
a CPU;
a flow statistic module, for receiving information regarding vehicles passing through an underground inductance coil of each lane, processing the information into traffic data of each lane and each direction, and sending the traffic data to the CPU;
an intelligent light control module, for receiving from a panoramic camera pictures of vehicles on each lane and on each direction, processing the pictures into queuing data of the corresponding lane and direction, and sending the queuing data to the CPU;
a vehicle speed detection module, for receiving information regarding vehicles passing through the underground inductance coil of each lane, processing the information into speed data, and sending the speed data to the CPU;
a snapshot control module, for receiving snapshot commands from the CPU, creating snapshot control signals, and sending the snapshot control signals to snapshot cameras; and
a light control module, for receiving lighting mode control commands from the CPU, creating light control signals in accordance with pre-stored lighting modes, and sending the light control signals to a light control circuit to switch on/off the corresponding power supply circuits, wherein the light control module receives light switching commands from the CPU whose execution will be given priority, creates and sends light control signals to the light control circuit to switch on/off the corresponding power supply circuits, and finally resumes the lighting mode after the light switching commands are executed;
wherein the CPU receives and stores the traffic data of each lane and each direction, creates and stores analytic traffic data, and outputs the analytic traffic data in accordance with external commands, the CPU further receiving the queuing data of each lane and each direction as well as mode parameters input by a lighting mode selector, creating lighting mode control commands according to the mode parameters, and sending the lighting mode control commands to the light control module, the CPU further receiving light switching information input by a manual light switching device, creating light switching commands, and sending the light switching commands to the light control module, the CPU further receiving visibility data from a visibility sensor, retrieving a speed limit corresponding to the visibility data in a database, and storing the speed limit in a speed limit storage, the CPU further receiving the speed data from the vehicle speed detection module, comparing the speed data with the speed limit in the speed limit storage, and sending a snapshot command, if the speed data is greater than the speed limit, to the snapshot control module, the CPU further receiving snapshot images from the snapshot cameras through a video capture card, recognizing the vehicle identification number, and storing the images and corresponding number in a blacklist database.

2. The integrated intersection traffic control system according to claim 1, wherein the snapshot cameras include longitudinal and lateral cameras respectively for taking longitudinal and lateral snapshots, wherein the operation of the cameras is controlled by the vehicle speed detection module, the visibility sensor and the CPU, wherein the longitudinal and lateral cameras take snapshots in response to the commands from the CPU and send the punishable vehicle images to the CPU, wherein the vehicle speed detection module obtains the speed information and the CPU receives and processes the speed information into speed data, compares the speed data with the speed limit, makes a decision, and instantly commands the snapshot cameras to take snapshots as well as recognizes the vehicle identification number by analyzing the picture if the actual speed is greater than the speed limit.

3. The integrated intersection traffic control system according to claim 2, wherein the visibility sensor captures and sends visibility data to the CPU to retrieve a pre-stored speed limit corresponding to the visibility level for comparison with the actual speed.

4. The integrated intersection traffic control system according to claim 3, wherein the CPU controls longitudinal and lateral snap-shooting through corresponding longitudinal and lateral cameras, wherein the CPU is provided with a master communication interface and connected with a red light detector which detects the red light condition in real-time and sends the condition data to the CPU, wherein the longitudinal and lateral cameras includes the master communication interface, a video controller and a camera communication interface, wherein the vehicle speed detection module calculates the speed data according to the output of the underground inductance coil, and wherein the CPU creates a speed limit corresponding to the visibility data sent by the visibility sensor module and stores the speed limit data in a speed limit storage for future decision of speeding.

5. The integrated intersection traffic control system according to claim 4, wherein the CPU has an embedded ARM4 processor with corresponding analysis and control programs of data gathering, error handling and logic calculating to the input information regarding red light condition, traffic condition and vehicle speed, wherein when a red light violation or speeding is confirmed, the CPU sends related information through the master communication interface to the longitudinal and lateral snapshot control modules and the longitudinal and lateral snapshot control modules calculate the best snapshot time and position of the corresponding cameras and send the results to the corresponding cameras through the camera communication interface, wherein the cameras take a snapshot or video of the scene correspondingly.

6. The integrated intersection traffic control system according to claim 5, wherein the visibility sensor comprises a laser transmitter and a laser receiver, wherein the visibility data is obtained by calculating the ratio of a transmitted light intensity to a received light intensity.

7. The integrated intersection traffic control system according to claim 6, wherein the laser receiver has a photosensitive element to receive laser which is sensitive only to laser of predetermined frequencies.

8. The integrated intersection traffic control system according to claim 7, wherein the laser receiver is equipped with a tubular shade for prevention of the background light.

9. The integrated intersection traffic control system according to claim 8, further comprising a real-time speed limit display in front of the speed detection module, wherein the said speed limit display is connected to the CPU and the CPU sends the speed limit data stored in the speed limit storage to the speed limit display for displaying in real time.

10. The integrated intersection traffic control system according to claim 9, wherein the lighting mode selector, the manual light switching device and the intelligent light control module control the traffic lights by sending information to the CPU, wherein the lighting mode selector sends light control parameters to the CPU, the manual light switching device assigns priority to a manual operation, and the intelligent light control module receives real-time videos of traffic condition on each direction from the panoramic cameras through the video capture card, analyzes the videos for queuing data of the vehicles, chooses an optimum lighting mode according to the queuing data, and sends commands to the light control module to change the light control parameters stored in the light control module.

11. The integrated intersection traffic control system according to claim 2, wherein the visibility sensor comprises a laser transmitter and a laser receiver, wherein the visibility data is obtained by calculating the ratio of a transmitted light intensity to a received light intensity.

12. The integrated intersection traffic control system according to claim 11, wherein the laser receiver has a photosensitive element to receive laser which is sensitive only to laser of predetermined frequencies.

13. The integrated intersection traffic control system according to claim 12, wherein the laser receiver is equipped with a tubular shade for prevention of the background light.

14. The integrated intersection traffic control system according to claim 13, further comprising a real-time speed limit display in front of the speed detection module, wherein the said speed limit display is connected to the CPU and the CPU sends the speed limit data stored in the speed limit storage to the speed limit display for displaying in real time.

15. The integrated intersection traffic control system according to claim 14, wherein the lighting mode selector, the manual light switching device and the intelligent light control module control the traffic lights by sending information to the CPU, where the lighting mode selector sends light control parameters to the CPU, the manual light switching device assigns priority to a manual operation, and the intelligent light control module receives real-time videos of traffic condition on each direction from the panoramic cameras through the video capture card, analyzes the videos for queuing data of the vehicles, chooses an optimum lighting mode according to the queuing data, and sends commands to the light control module to change the light control parameters stored in the light control module.

16. The integrated intersection traffic control system according to claim 3, wherein the visibility sensor comprises a laser transmitter and a laser receiver, wherein the visibility data is obtained by calculating the ratio of a transmitted light intensity to a received light intensity.

17. The integrated intersection traffic control system according to claim 11, wherein the laser receiver has a photosensitive element to receive laser which is sensitive only to laser of predetermined frequencies.

18. The integrated intersection traffic control system according to claim 12, wherein the laser receiver is equipped with a tubular shade for prevention of the background light.

19. The integrated intersection traffic control system according to claim 13, further comprising a real-time speed limit display in front of the speed detection module, wherein the said speed limit display is connected to the CPU and the CPU sends the speed limit data stored in the speed limit storage to the speed limit display for displaying in real time.

20. The integrated intersection traffic control system according to claim 14, wherein the lighting mode selector, the manual light switching device and the intelligent light control module control the traffic lights by sending information to the CPU, where the lighting mode selector sends light control parameters to the CPU, the manual light switching device assigns priority to a manual operation, and the intelligent light control module receives real-time videos of traffic condition on each direction from the panoramic cameras through the video capture card, analyzes the videos for queuing data of the vehicles, chooses an optimum lighting mode according to the queuing data, and sends commands to the light control module to change the light control parameters stored in the light control module.
